(19) United States
(12) Patent Application Publication
(10) Pub. No.: US 2024/0343327 A1
(43) Pub. Date: Oct. 17, 2024

(54) MOBILE OBJECT AND ROBOT APPARATUS

(71) Applicant: SONY GROUP CORPORATION, TOKYO (JP)

(72) Inventors: YASUHISA KAMIKAWA, TOKYO (JP); NORIAKI TAKAGI, TOKYO (JP)

(21) Appl. No.: 18/683,303

(22) PCT Filed: Feb. 21, 2022
(86) PCT No.: PCT/JP2022/006919

§ 371 Date: Feb. 13, 2024

(30) Foreign Application Priority Data
Sep. 10, 2021 (JP) 2021-147384

(51) Int. Cl. B62D 57/024; B62D 57/028

(52) U.S. Cl. CPC B62D 57/024; B62D 57/028

(57) ABSTRACT

To provide a mobile object and a robot apparatus including a leg that is prevented from interfering with the outside without deteriorating usability. A mobile object includes: a main body portion; a plurality of legs connected to the main body portion via joints rotatable about an axis extending in a first direction that is parallel to a traveling surface; and an exterior portion that covers both sides in the first direction of the main body portion and an upper side of the main body portion opposite to a side near the traveling surface to enclose the main body portion and the plurality of legs.

### TECHNICAL FIELD

The present disclosure relates to a mobile object and a robot apparatus.

### BACKGROUND ART

In recent years, a legged mobile object has been developed which is capable of freely moving by walking on a plurality of legs on an uneven surface such as stairs or an unpaved road. In addition, attention has been also focused on a leg-wheel type mobile object having a plurality of legs the distal ends of which are provided with wheels that can be driven by a motor or the like so that the mobile object is capable of moving by walking on the legs on an uneven surface and also capable of traveling with the wheels on a flat surface such as a paved road.

Regarding a mobile object having a movable portion such as a leg, it has been proposed to cover the movable portion with a housing or the like in order to prevent other objects from getting caught therein. For example, the following Patent Document 1 discloses a robot having four extendable legs in a lower part of a housing. The robot disclosed in Patent Document 1 prevents exposure of the movable portion to the outside by accommodating the legs in the housing when the legs are contracted.

### CITATION LIST

### Patent Document

Patent Document 1: Japanese Patent Application Laid-Open No. 2020-95313

### SUMMARY OF THE INVENTION

### Problems to be Solved by the Invention

In contrast to the robot disclosed in Patent Document 1, however, a legged mobile object which moves by walking has an extremely wide movable range of the legs. Therefore, in a case where a housing that covers the entire movable range of the legs is provided, the size of the housing should be large, which significantly deteriorates the usability of the mobile object which moves by walking. Consequently, it is desirable for the legged mobile object that moves by walking to be free of interference between the legs and the outside without deterioration in usability.

Therefore, the present disclosure proposes a new and improved mobile object and robot apparatus which are free of interference between the legs and the outside without deterioration in usability.

### Solutions to Problems

According to the present disclosure, there is provided a mobile object including: a main body portion; a plurality of legs connected to the main body portion via joints rotatable about an axis extending in a first direction that is parallel to a traveling surface; and an exterior portion that covers both sides in the first direction of the main body portion and an upper side of the main body portion opposite to a side near the traveling surface to enclose the main body portion and the plurality of legs.

In addition, according to the present disclosure, there is further provided a robot apparatus including: a main body portion; a plurality of legs connected to the main body portion via joints rotatable about an axis extending in a first direction that is parallel to a traveling surface; and an exterior portion that covers both sides in the first direction of the main body portion and an upper side of the main body portion opposite to a side near the traveling surface to enclose the main body portion and the plurality of legs.

### BRIEF DESCRIPTION OF DRAWINGS

FIG. 1 is a perspective view illustrating an appearance of a mobile object according to a first configuration example.

FIG. 2 is a front view of the mobile object illustrated in FIG. 1 as viewed in a direction opposing a traveling direction.

FIG. 3 is a side view of the mobile object illustrated in FIG. 1 as viewed in a direction orthogonal to the traveling direction.

FIG. 4 is a bottom view of the mobile object illustrated in FIG. 1 as viewed from a traveling surface.

FIG. 5 is a schematic diagram illustrating a state of the mobile object illustrated in FIG. 1 walking on legs.

FIG. 6 is a perspective view illustrating an appearance of a mobile object according to a second configuration example.

FIG. 7 is a perspective view illustrating an appearance of a mobile object according to an embodiment of the present disclosure.

FIG. 8 is a front view of the mobile object illustrated in FIG. 7 as viewed in a direction opposing a traveling direction.

FIG. 9 is a top view of the mobile object illustrating regions at which a mobile object main body and an exterior portion are connected.

FIG. 10 is a side view of the mobile object illustrating the regions at which the mobile object main body and the exterior portion are connected.

FIG. 11 is a side view of a mobile object according to a first modification as viewed in a pitch axis direction.

FIG. 12 is an explanatory view illustrating part of a leg and a projecting portion in an extracted manner.

FIG. 13 is a schematic cross-sectional view illustrating the positional relationship among the legs, the projecting portions, and the exterior portion as viewed in a direction opposing the traveling direction.

FIG. 14 is a perspective view illustrating an appearance of a mobile object according to a second modification.

FIG. 15 is a top view for explaining an internal configuration of the mobile object according to the second modification.

FIG. 16 is a perspective view illustrating an appearance of a mobile object according to a third modification.

FIG. 17 is a perspective view illustrating an appearance of a mobile object according to a fourth modification.

FIG. 18 is a perspective view illustrating an appearance of a mobile object according to a fifth modification.

FIG. 19 is a perspective view illustrating an appearance of a mobile object according to a sixth modification.

FIG. 20 is a perspective view illustrating an appearance of a mobile object according to a specific example.

FIG. 21 is a top view of the mobile object illustrated in FIG. 20 in direction A.

FIG. 22 is a side view of the mobile object illustrated in FIG. 20 in direction B.

FIG. 23 is a front view of the mobile object illustrated in FIG. 20 in direction C.

FIG. 24 is a bottom view of the mobile object illustrated in FIG. 20 in direction D.

FIG. 25 is a perspective view illustrating an appearance of the mobile object in a state where each leg is extended.

FIG. 26 is a top view of the mobile object illustrated in FIG. 25 in direction A.

FIG. 27 is a side view of the mobile object illustrated in FIG. 25 in direction B.

FIG. 28 is a front view of the mobile object illustrated in FIG. 25 in direction C.

FIG. 29 is a bottom view of the mobile object illustrated in FIG. 25 in direction D.

FIG. 30 is a perspective view illustrating an appearance of the mobile object in a state where the legs are swung out in the traveling direction.

FIG. 31 is a top view of the mobile object illustrated in FIG. 30 in direction A.

FIG. 32 is a side view of the mobile object illustrated in FIG. 30 in direction B.

FIG. 33 is a front view of the mobile object illustrated in FIG. 30 in direction C.

FIG. 34 is a bottom view of the mobile object illustrated in FIG. 30 in direction D.

FIG. 35 is a back view of the mobile object illustrated in FIG. 30 in direction E.

FIG. 36 is a perspective view of the mobile object illustrated in FIG. 30 in which an exterior portion is exploded.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference sign, and redundant descriptions are omitted.

Note that the description will be given in the following order.
1. Mobile object
1.1 First configuration example
1.2. Second configuration example
2. Exterior portion
2.1. Configuration example
2.2. Modifications
3. Specific example

### 1. Mobile Object

### 1.1 First Configuration Example

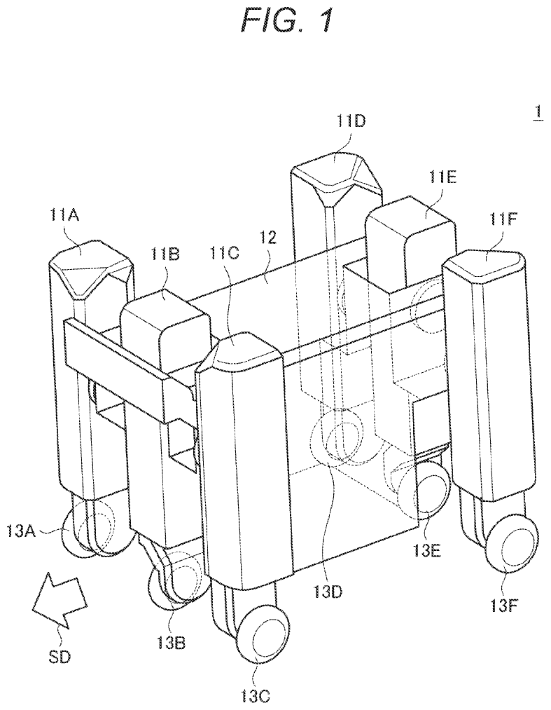

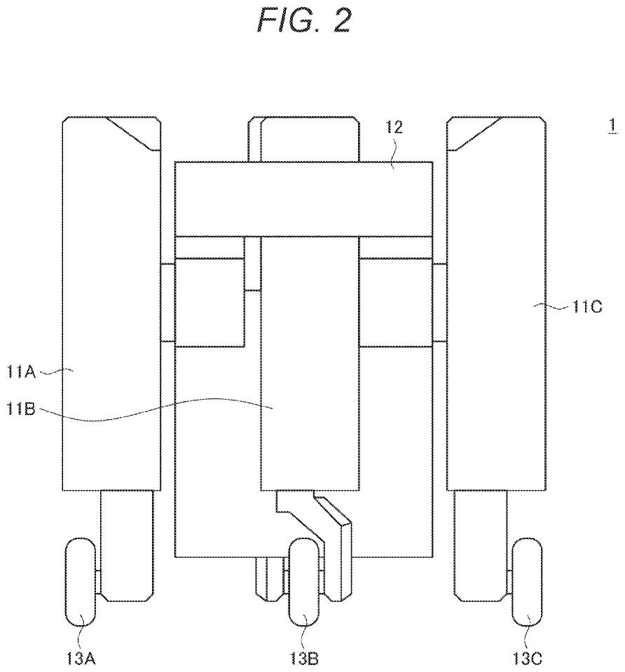

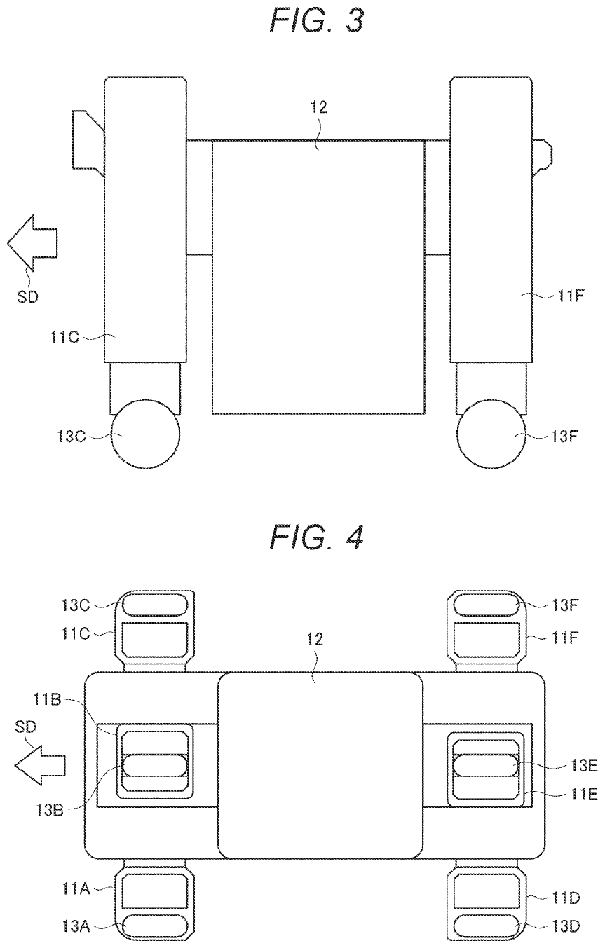

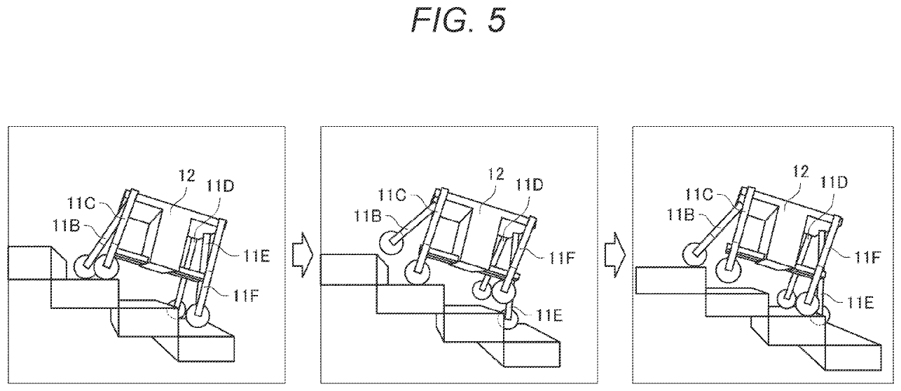

First, a first configuration example of a mobile object to which the technology according to the present disclosure is applied will be described with reference to FIGS. 1 to 5. FIG. 1 is a perspective view illustrating an appearance of a mobile object 1 according to the first configuration example. FIG. 2 is a front view of the mobile object 1 illustrated in FIG. 1 as viewed in a direction opposing a traveling direction SD. FIG. 3 is a side view of the mobile object 1 illustrated in FIG. 1 as viewed in a direction orthogonal to the traveling direction SD. FIG. 4 is a bottom view of the mobile object 1 illustrated in FIG. 1 as viewed from a traveling surface. FIG. 5 is a schematic diagram illustrating a state of the mobile object 1 illustrated in FIG. 1 walking on legs.

As illustrated in FIGS. 1 to 5, the mobile object 1 includes a main body portion 12, a plurality of legs 11A, 11B, 11C, 11D, 11E, and 11F, and wheels 13A, 13B, 13C, 13D, 13E, and 13F. The mobile object 1 is, for example, a leg-wheel type robot apparatus having six legs.

Hereinafter, the legs 11A, 11B, 11C, 11D, 11E, and 11F are collectively referred to as legs 11 in a case where they are not distinguished from each other. In addition, the wheels 13A, 13B, 13C, 13D, 13E, and 13F are collectively referred to as wheels 13 in a case where they are not distinguished from each other.

The main body portion 12 corresponds to a body of the mobile object 1. The main body portion 12 is provided with, for example, a control device that controls the overall operation of the mobile object 1, a sensor device that senses the external environment of the mobile object 1, a power supply device that supplies power to each unit of the mobile object 1, and the like.

The leg 11 is rotatably attached to the main body portion 12 on one end side (hereinafter, also referred to as a rear end side) and is grounded to the traveling surface via the wheel 13 on the other end side (hereinafter, also referred to as a distal end side) to support the main body portion 12.

Specifically, the leg 11 includes a plurality of links connected to each other so as to be linearly movable, and is rotatable about an axis on the rear end side orthogonal to the traveling direction SD. The leg 11 can extend and contract in one direction by extending and contracting the plurality of connected links. This allows the mobile object 1 to walk using the plurality of legs 11 supporting the main body portion 12 by alternately rotating and extending and contracting the legs 11. Therefore, the mobile object 1 can walk using the legs 11 on an uneven traveling surface such as stairs or an unpaved road.

The wheel 13 is provided on the distal end side of each leg 11. The wheels 13 are driven by a motor or the like, or is rotated by following the movement of the mobile object 1, so that the mobile object 1 can travel on the wheels. Therefore, the mobile object 1 can travel on the wheels by rotating the wheels 13 while maintaining the posture of each leg 11 on a flat traveling surface such as a paved road.

More specifically, three legs 11A, 11B, and 11C are provided on the front side of the mobile object 1 with respect to the traveling direction SD. In addition, three legs 11D, 11E, and 11F are provided on the back side opposite to the front side with respect to the traveling direction SD.

Wheels 13A and 13C that rotate by being driven by a motor or the like are provided on the left and right legs 11A and 11C on the front side. Furthermore, wheels 13D and 13F that rotate by being driven by a motor or the like are provided on the left and right legs 11D and 11F on the back side.

The leg 11B provided between the legs 11A and 11C is provided with a wheel 13B that rotates by following the movement of the mobile object 1. In addition, the leg 11E provided between the legs 11D and 11F is provided with a wheel 13E that rotates by following the movement of the mobile object 1. Wheels translationally movable in all directions may serve as the wheels 13B and 13E. For example, the wheels 13B and 13E may have a turning axis that turns the direction of the wheel to be translationally movable in all directions.

According to such a configuration, the mobile object 1 can turn without a steering mechanism by grounding only the wheel 13B provided on the front side with respect to the traveling direction SD and the wheels 13D and 13F provided on the opposite side from the front side and traveling on the wheels. That is, the mobile object 1 can freely turn the direction of the wheel 13B, which serves as a trailing wheel, on the basis of the difference in rotation speed between the wheels 13D and 13F, which serve as drive wheels, and thus can freely turn right or left.

Similarly, the mobile object 1 can turn without a steering mechanism by grounding only the wheel 13E provided on the opposite side from the front side with respect to the traveling direction SD and the wheels 13A and 13C provided on the front side and traveling on the wheels. That is, the mobile object 1 can freely turn the direction of the wheel 13E, which serves as a trailing wheel, on the basis of the difference in rotation speed between the wheels 13A and 13C, which serve as drive wheels, and thus can freely turn right or left.

In addition, the mobile object 1 can ascend and descend a step such as a stair by walking on the legs while alternately grounding the three legs of the wheel 13B and the wheels 13D and 13F and the three legs of the wheels 13A and 13C and the wheel 13E, as illustrated in FIG. 5. Specifically, the mobile object 1 lifts the three legs of the wheels 13B, 13D, and 13F from a state where the six legs of the wheels 13B, 13D, and 13F and the wheels 13A, 13C, and 13E are grounded, and then causes the three legs of the wheels 13B, 13D, and 13F to be grounded on the step. Thereafter, the mobile object 1 lifts the three legs of the wheels 13A, 13C, and 13E grounded below the step, and then causes the three legs of the wheels 13A, 13C, and 13E to be grounded on the step, thereby ascending the step.

Since the three legs of the wheel 13B and the wheels 13D and 13F or the three legs of the wheels 13A and 13C and the wheel 13E are located at vertices of an isosceles triangle internally including the center of gravity position of the mobile object 1, the mobile object 1 can be stably supported by the three legs. Therefore, the mobile object 1 can stably walk on the legs by alternately grounding the three legs of the wheel 13B and the wheels 13D and 13F or the three legs of the wheels 13A and 13C and the wheel 13E.

### 1.2. Second Configuration Example

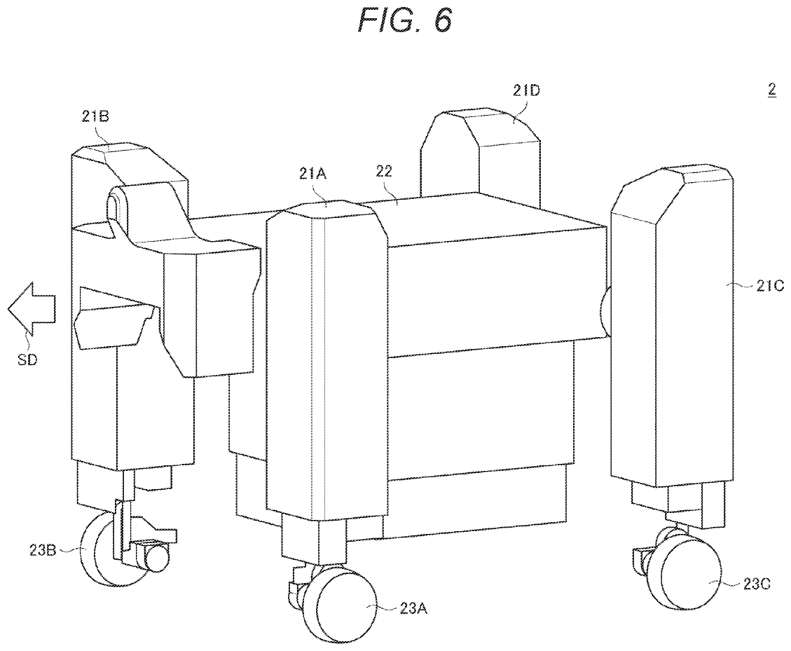

Next, a second configuration example of a mobile object to which the technology according to the present disclosure is applied will be described with reference to FIG. 6. FIG. 6 is a perspective view illustrating an appearance of a mobile object 2 according to the second configuration example.

As illustrated in FIG. 6, the mobile object 2 according to the present embodiment includes a main body portion 22, a plurality of legs 21A, 21B, 21C, and 21D, and wheels 23A, 23B, 23C, and 23D. The mobile object 2 is, for example, a leg-wheel type robot apparatus having four legs.

Hereinafter, the legs 21A, 21B, 21C, and 21D are collectively referred to as legs 21 in a case where they are not distinguished from each other. In addition, the wheels 23A, 23B, 23C, and 23D are collectively referred to as wheels 23 in a case where they are not distinguished from each other.

The main body portion 22 corresponds to a body of the mobile object 2. The main body portion 22 includes, for example, a control device that controls the overall operation of the mobile object 2, a sensor device that senses the external environment of the mobile object 2, a power supply device that supplies power to each unit of the mobile object 2, and the like.

The leg 21 is rotatably attached to the main body portion 22 on one end side (rear end side) and is grounded to the traveling surface via the wheel 23 on the other end side (distal end side) to support the main body portion 22.

Specifically, the leg 21 includes a plurality of links connected to each other so as to be linearly movable, and is rotatable about an axis on the rear end side orthogonal to a traveling direction SD. The leg 21 can extend and contract in one direction by moving the plurality of connected links in one direction. This allows the mobile object 2 to walk using the plurality of legs 21 supporting the main body portion 22 by alternately rotating and extending and contracting the plurality of legs 21.

The wheel 23 is provided on the distal end side of each leg 21. The wheels 23 rotate by being driven by a motor or the like, so that the mobile object 2 can travel on the wheels. The wheel 23 may be a general wheel which is movable in one direction, or may be a mecanum wheel or an omni wheel designed to be translationally movable in any direction. In a case where the wheel 23 is a mecanum wheel or an omni wheel, the mobile object 2 can translationally move in all directions without a steering mechanism.

The mobile object 2 having the above configuration can travel on the wheels by rotating the wheels 23 while maintaining the posture of each leg 21 on a flat traveling surface such as a paved road. The mobile object 2 can walk using the legs 21 by alternately rotating and extending and contracting each of the legs 21 on an uneven traveling surface such as stairs or an unpaved road.

### 2. Exterior Portion

### 2.1. Configuration Example

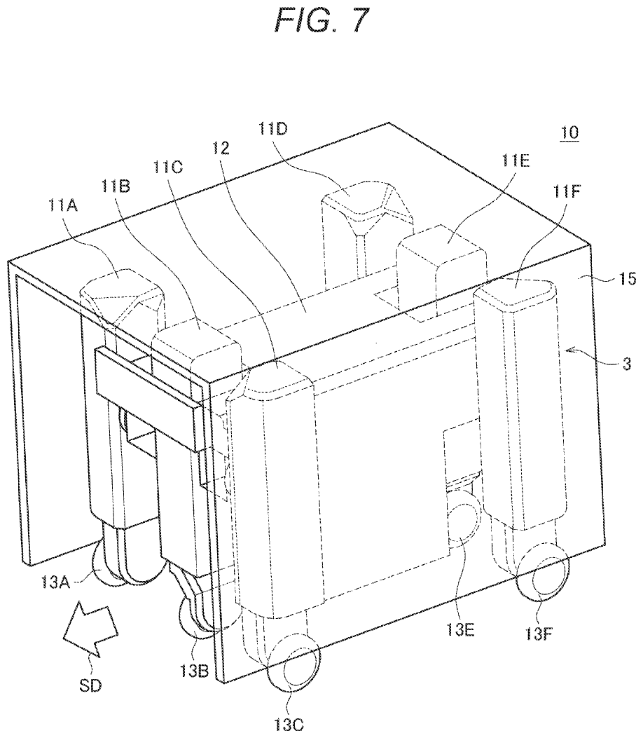

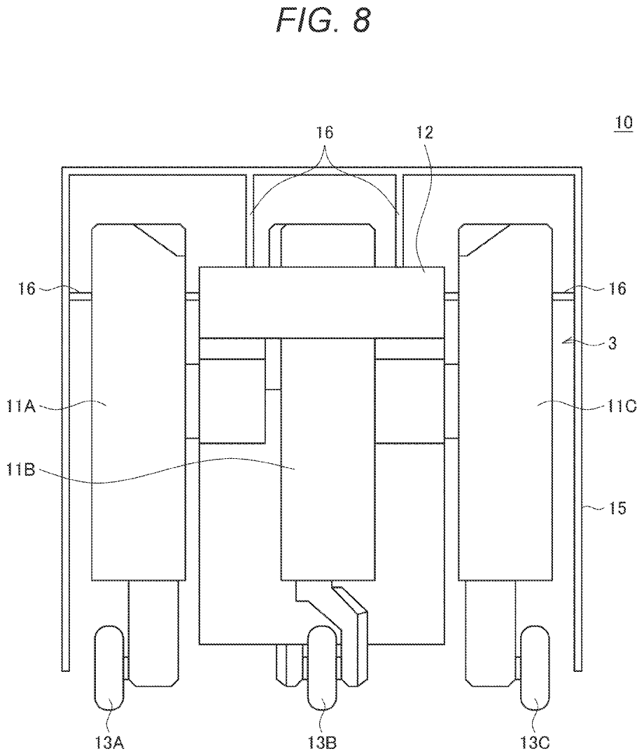

Next, the technology according to the present disclosure will be described with reference to FIGS. 7 to 10. FIG. 7 is a perspective view illustrating an appearance of a mobile object 10 according to an embodiment of the present disclosure. FIG. 8 is a front view of the mobile object 10 illustrated in FIG. 7 as viewed in a direction opposing a traveling direction SD.

As illustrated in FIG. 7, the mobile object 10 according to the present embodiment includes a mobile object main body 3, an exterior portion 15, and connecting portions 16.

The mobile object main body 3 is, for example, the above-described six-leg mobile object 1, and includes legs 11 that are not rotatable about a roll axis extending in a traveling direction SD and is rotatable about a pitch axis orthogonal to the traveling direction SD. Note that although the following description will be given on the assumption that the above-described mobile object 1 serve as the mobile object main body 3, the above-described four-leg mobile object 2 may serve as the mobile object main body 3.

The mobile object main body 3 has three degrees of freedom of a joint that rotates the leg 11 about the pitch axis with respect to the main body portion 12, a prismatic joint that extends and contracts the leg 11, and the wheel 13, and hence can travel on the wheels and also can walk on the legs by using these three degrees of freedom. Specifically, by using these three degrees of freedom, the mobile object main body 3 can perform linear movement and turning movement by rotating the wheels 13 on a flat surface, and treading movement by alternately grounding the legs 11 on an uneven surface.

The exterior portion 15 is a member that covers the mobile object main body 3. Specifically, the exterior portion 15 is a member having a shape of a bent plate that covers both sides in the pitch axis direction orthogonal to the traveling direction SD of the mobile object main body 3 and an upper side opposite to the side near the traveling surface of the mobile object main body 3. The exterior portion 15 may contain, for example, a rigid material such as metal or engineering plastic.

The mobile object 10 walks on the legs by rotating the legs 11 about a pitch axis orthogonal to the traveling direction SD and extending and contracting the legs 11. Therefore, by virtue of the openings on both sides in the roll axis direction extending in the traveling direction SD, the exterior portion 15 can prevent interference with the legs 11 rotating about the pitch axis. On the other hand, since the legs 11 of the mobile object 10 do not have a movable range in the pitch axis direction orthogonal to the traveling direction SD, the legs 11 do not interfere with the exterior portion 15 provided on both sides in the pitch axis direction of the main body portion 12. With this configuration, the mobile object 10 is less liable to cause interference between the moving legs 11 and outside objects at the time of being accessed in the pitch axis direction (that is, the lateral direction) of the mobile object 10 or passing by an outside object during walking. Therefore, the mobile object 10 can be improved in safety during walking on the legs.

The connecting portions 16 are members that connect the mobile object main body 3 and the exterior portion 15. Specifically, the connecting portions 16 are rod-like structural members, and are each fastened to the mobile object main body 3 and the exterior portion 15 by fasteners such as bolts and nuts, for example, to connect the mobile object main body 3 and the exterior portion 15. For example, the connecting portions 16 may connect the upper surface of the exterior portion 15 and the upper surface of the main body portion 12, and connect each side surface of the exterior portion 15 in the pitch axis direction and a corresponding side surface of the main body portion 12 of the mobile object main body 3.

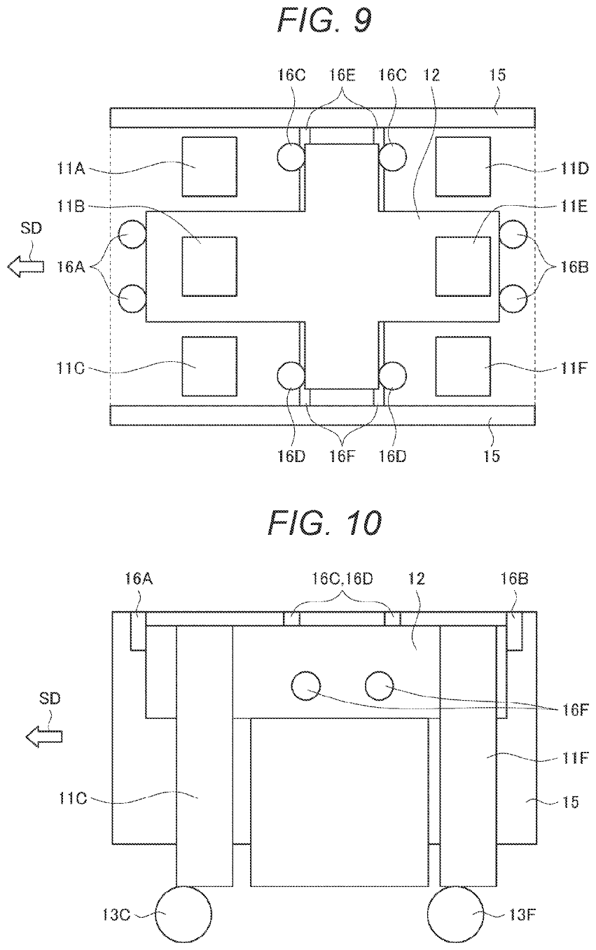

Regions at which the mobile object main body 3 and the exterior portion 15 are connected will now be described more specifically with reference to FIGS. 9 and 10. FIG. 9 is a top view of the mobile object 10 illustrating regions at which the mobile object main body 3 and the exterior portion 15 are connected. FIG. 10 is a side view of the mobile object 10 illustrating the regions at which the mobile object main body 3 and the exterior portion 15 are connected.

As illustrated in FIGS. 9 and 10, the main body portion 12 is provided in a shape in which central portions of both side surfaces in the pitch axis direction protrude and central portions in the roll axis direction protrude so as to avoid legs 11A, 11C, 11D, and 11F provided at four corners. With this configuration, the main body portion 12 is provided in such a shape that can be positioned adjacent to the exterior portion 15 while keeping a movable range of the legs 11A, 11C, 11D, and 11F, so that the main body portion 12 can be more closely connected to the exterior portion 15 while avoiding interference with the legs 11.

In addition, the main body portion 12 is provided so as to incorporate the legs 11B and 11E into the central portion protruding in the roll axis direction. This allows the main body portion 12 to be provided with various sensors (such as an imaging device or a distance measuring sensor) that sense the outside at the central portion protruding in the roll axis direction. These various sensors provided to the end portion at the front with respect to the traveling direction SD allow the main body portion 12 to promptly acquire information on the outside over a wider range.

The mobile object main body 3 and the exterior portion 15 are connected by connecting portions 16A, 16B, 16C, 16D, 16E, and 16F provided at connecting regions separated from each other. The connecting portions 16A, 16B, 16C, 16D, 16E, and 16F have alphabetical branch numbers so that the connecting portions 16 illustrated in FIG. 8 can be distinguished from each other. At least two or more connecting portions 16A, 16B, 16C, 16D, 16E, and 16 may be provided at each connecting region.

The connecting portions 16A and 16B are provided at respective end portions on both sides in the roll axis direction on the upper surface of the main body portion 12 to connect the upper surface of the main body portion 12 and the upper surface of the exterior portion 15. The connecting portions 16C and 16D are provided at respective end portions on both sides in the pitch axis direction on the upper surface of the main body portion 12 to connect the upper surface of the main body portion 12 and the upper surface of the exterior portion 15. The connecting portions 16E and 16F are provided at respective side surfaces on both sides in the pitch axis direction of the main body portion 12 to connect the side surfaces of the central portion protruding to the both sides in the pitch axis direction of the main body portion 12 and both side surfaces of the exterior portion 15. The exterior portion 15 is connected to a plurality of surfaces (that is, the upper surface and both side surfaces) of the main body portion 12 via the connecting portions 16A, 16B, 16C, 16D, 16E, and 16F, so that rigidity of connection between the exterior portion 15 and the main body portion 12 can be improved. With this configuration, the mobile object 10 can exhibit enhanced rigidity against vibrations of the exterior portion 15.

The mobile object 10 has the connecting portions 16 (connecting portions 16A, 16B, 16C, and 16D) provided at both end portions in the pitch axis direction and at both end portions in the roll axis direction on the upper surface of the main body portion 12. With this configuration, the mobile object 10 has the main body portion 12 and the exterior portion 15 which are connected at a plurality of connecting regions separated from each other and hence, the main body portion 12 and the exterior portion 15 can be connected with higher rigidity.

In addition, since such a configuration allows the center of the upper surface of the main body portion 12 to be free of the connecting portion 16, the mobile object 10 can be provided with an opening or the like for accessing the main body portion 12 at the center of the upper surface of the exterior portion 15. With this configuration, the mobile object 10 allows for easy access to the main body portion 12 without detaching the exterior portion 15, which improves maintainability of the main body portion 12 and facilitates functional expansion of the main body portion 12 by connection of an external device.

### 2.2. Modifications

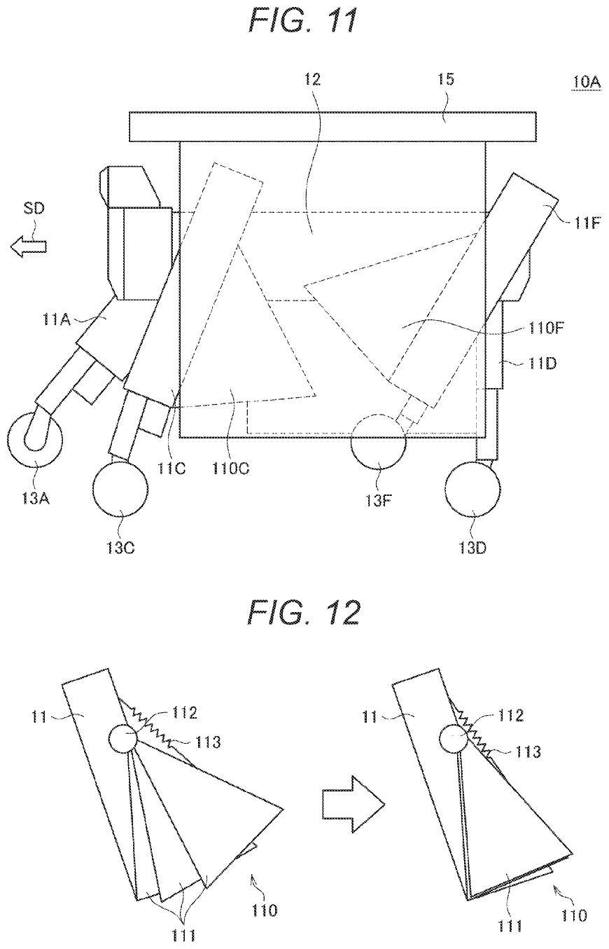

Next, first to sixth modifications of the mobile object 10 according to the present embodiment will be described with reference to FIGS. 11 to 19.

### First Modification

FIG. 11 is a side view of a mobile object 10A according to a first modification as viewed in the pitch axis direction. As illustrated in FIG. 11, the mobile object 10A is provided with a projecting portion 110C projecting from the leg 11C toward the central portion in the roll axis direction of the main body portion 12 and a projecting portion 110F projecting from the leg 11F toward the central portion in the roll axis direction of the main body portion 12. Similarly, although not illustrated, there are also provided a projecting portion projecting from the leg 11A toward the central portion in the roll axis direction of the main body portion 12 and a projecting portion projecting from the leg 11D toward the central portion in the roll axis direction of the main body portion 12. Hereinafter, the projecting portions 110C and 110F are collectively referred to as projecting portions 110 in a case where they are not distinguished from each other.

The projecting portion 110 is provided in such a shape that reversely tapers from the rear end side toward the distal end side of the leg 11. Specifically, the projecting portion 110 may be provided in a fan shape having a vertex on the rear end side of the leg 11 and expanding toward the distal end side, or may be provided in a triangular shape expanding from the rear end side toward the distal end side of the leg 11. The projecting portion 110 projects from the leg 11 toward the central portion in the roll axis direction of the main body portion 12, so that it is possible to prevent generation of a gap that would catch an outside object between the exterior portion 15 and the leg 11 externally swung out from the main body portion 12.

For example, when the leg 11C is swung out in the traveling direction SD of the mobile object 10A while the mobile object 10A is walking, a gap is generated between the distal end side of the leg 11C and the exterior portion 15. When the leg 11C is then swung back with respect to the traveling direction SD of the mobile object 10A, the gap generated between the distal end side of the leg 11C and the exterior portion 15 is closed, so that there is a possibility that an outside object is caught between the leg 11C and the exterior portion 15. The projecting portion 110C provided to project from the leg 11C backward with respect to the traveling direction SD can prevent generation of a gap between the exterior portion 15 and the leg 11C swung out forward with respect to the traveling direction SD of the mobile object 10A. With this configuration, since the projecting portion 110 can prevent outside objects from being caught between the exterior portion 15 and the leg 11, the safety of the mobile object 10A can be further improved.

However, in a case where the projecting portion 110 is provided on each of the legs 11A and 11C on the front side and the legs 11D and 11F on the opposite side with respect to the traveling direction SD of the mobile object 10A, the projecting portions 110 may interfere with each other. For example, the projecting portion 110C projecting backward from the leg 11C and the projecting portion 110F projecting forward from the leg 11F with respect to the traveling direction SD may interfere with each other when the leg 11C swings back and the leg 11F swings forward with respect to the traveling direction SD.

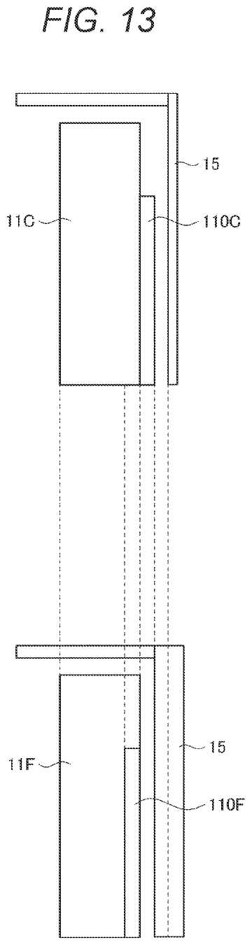

In order to prevent interference between the projecting portions 110 provided on the legs 11A and 11C and the projecting portions 110 provided on the legs 11D and 11F, for example, the following measures illustrated in FIG. 12 or 13 may be employed. FIG. 12 is an explanatory view illustrating part of the leg 11 and the projecting portion 110 in an extracted manner. FIG. 13 is a schematic cross-sectional view illustrating the positional relationship among the legs 11, the projecting portions 110, and the exterior portion 15 as viewed in a direction opposing the traveling direction SD.

As illustrated in FIG. 12, the projecting portion 110 may include a plurality of fan-shaped members 111 having a connection point 112 as a vertex provided on the rear end side of the leg 11, for example. The plurality of fan-shaped members 111 is connected so as to be rotatable relative to each other about the connection point 112, and is spread by tension of an elastic member 113 provided between the leg 11 and the plurality of fan-shaped members 111. Note that the tension of the elastic member 113 should be sufficiently weak with respect to the torque of the leg 11 swinging forward or backward.

Specifically, the plurality of fan-shaped members 111 may be spread by tension of the elastic member 113 to increase the central angle around the connection point 112. With this configuration, in a case where the projecting portion 110 collides with the projecting portion 110 provided on another leg 11, the plurality of fan-shaped members 111 can be overlapped and contracted to reduce the central angle around the connection point 112. Therefore, the mobile object 10A can prevent the interference between the projecting portions 110 from affecting the legs 11 swinging forward or backward.

As illustrated in FIG. 13, as another example, the projecting portion 110C provided on the leg 11C on the front and the projecting portion 110F provided on the leg 11F on the opposite side with respect to the traveling direction SD may be shifted from each other in the pitch axis direction. For example, the projecting portion 110C may be shifted in position to be nearer to the exterior portion 15 than the projecting portion 110F. With this configuration, when the leg 11C swings backward and the leg 11F swings forward with respect to the traveling direction SD, the projecting portion 110C and the projecting portion 110F can pass next to one another in the pitch axis direction without interfering with each other. Therefore, the mobile object 10A can prevent the interference between the projecting portions 110 from affecting the legs 11 swinging forward or backward.

However, since the projecting portion 110F is provided at a position farther from the exterior portion 15 than the projecting portion 110C, a gap may be generated between the projecting portion 110F and the exterior portion 15. In order to reduce such a gap between the projecting portion 110F and the exterior portion 15, as an example, the exterior portion 15 overlapping the projecting portion 110F may be thicker than the exterior portion 15 overlapping the projecting portion 110C. In addition, as another example, the gap between the projecting portion 110F and the exterior portion 15 that overlaps the projecting portion 110F may be reduced by folding back the end of the opening of the exterior portion 15 through which the leg 11F swings forward or backward.

Note that it goes without saying that the projecting portion 110F may be shifted in position to be nearer to the exterior portion 15 than the projecting portion 110C, in contrast to the above.

### Second Modification

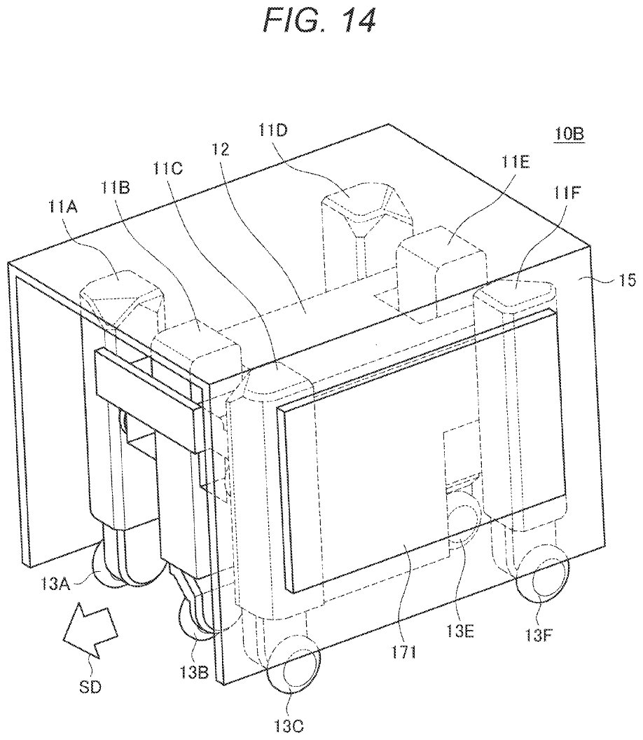

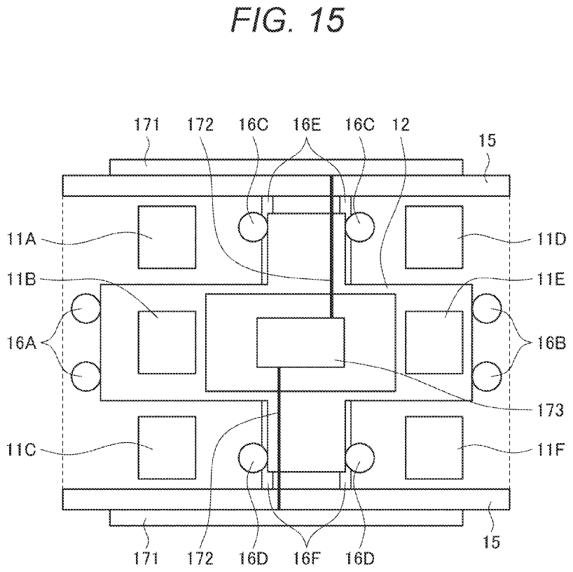

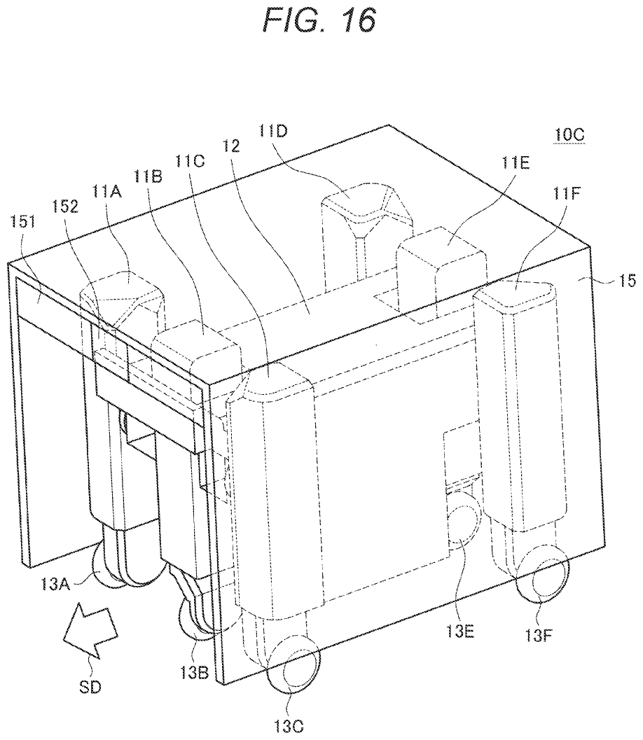

FIG. 14 is a perspective view illustrating an appearance of a mobile object 10B according to a second modification. FIG. 15 is a top view for explaining an internal configuration of the mobile object 10B according to the second modification. As illustrated in FIG. 14, the mobile object 10B is provided with a display unit 171 on the outer side of the side surface in the pitch axis direction of the exterior portion 15. The display unit 171 may be, for example, a thin display device such as a liquid crystal display or an OLED display, or a touch panel display that accepts touch input. This allows the exterior portion 15 to have the highly visible and large display unit 171, and therefore the mobile object 10B can more readily transmit information to the outside.

In addition, as illustrated in FIG. 15, the display unit 171 is connected to a control device 173 provided in the main body portion 12 via a wiring group 172 extending from the inner side of the side surface in the pitch axis direction of the exterior portion 15 to the main body portion 12, and images to be displayed are controlled by the control device 173. The mobile object 10B allows for easy access to the main body portion 12 from the upper surface of the exterior portion 15, so that the control device 173 and the display unit 171 can be more easily connected.

### Third Modification

FIG. 16 is a perspective view illustrating an appearance of a mobile object 10C according to a third modification. As illustrated in FIG. 16, the mobile object 10C is provided with rib portions 151 on upper portions of the openings on both sides in the roll axis direction of the exterior portion 15 to partially shield the openings.

The rib portion 151 is provided in a size that does not hinder the movement of the legs 11, and is connected to both side surfaces in the pitch axis direction and an upper surface of the exterior portion 15. The rib portion 151 can improve the rigidity of the entire exterior portion 15. In addition, since the rib portion 151 extends from the upper surface of the exterior portion 15 to form a bent structure, it can also function as a handle of the mobile object 10C. This allows the mobile object 10C to be easily moved by being pulled via the rib portion 151 when the power is off. Furthermore, the rib portion 151 may be provided with an output unit 152 including a light source, a display, a signal, or the like. The output unit 152 is supplied with power and a control signal from the main body portion 12 via wiring extending from the inside of the rib portion 151 of the exterior portion 15 to the main body portion 12. This allows the mobile object 10C to perform illumination of the outside, notification of the state of the device to the outside, or notification of the traveling direction to the outside via the output unit 152 of the rib portion 151.

### Fourth Modification

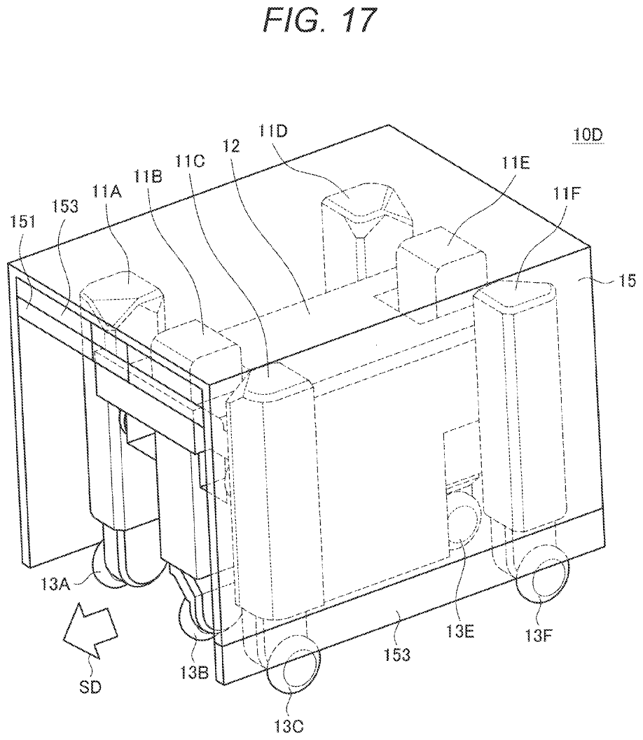

FIG. 17 is a perspective view illustrating an appearance of a mobile object 10D according to a fourth modification. As illustrated in FIG. 17, the mobile object 10D is provided with rib portions 151 on upper portions of the openings on both sides in the roll axis direction of the exterior portion 15 to partially shield the openings, similarly to the mobile object 10C according to the third modification. Furthermore, the mobile object 10D is provided with detection units 153 on both side surfaces in the pitch axis direction of the exterior portion 15 and the rib portions 151.

Specifically, the detection unit 153 is a bumper including a contact sensor that detects contact with an outside object, a proximity sensor that detects proximity of an outside object, or a distance measuring sensor that detects the distance to an outside object. The detection unit 153 is supplied with power and a control signal from the main body portion 12 via wiring extending from the inside of both side surfaces in the pitch axis direction and of the rib portions 151 of the exterior portion 15 to the main body portion 12. For example, the detection unit 153 may be provided in a band shape at the lower ends of both side surfaces in the pitch axis direction and at the rib portions 151 of the exterior portion 15. This allows the mobile object 10D to detect contact with or approach of an outside object by the detection unit 153 and stop, which allows for further improvement in safety.

### Fifth Modification

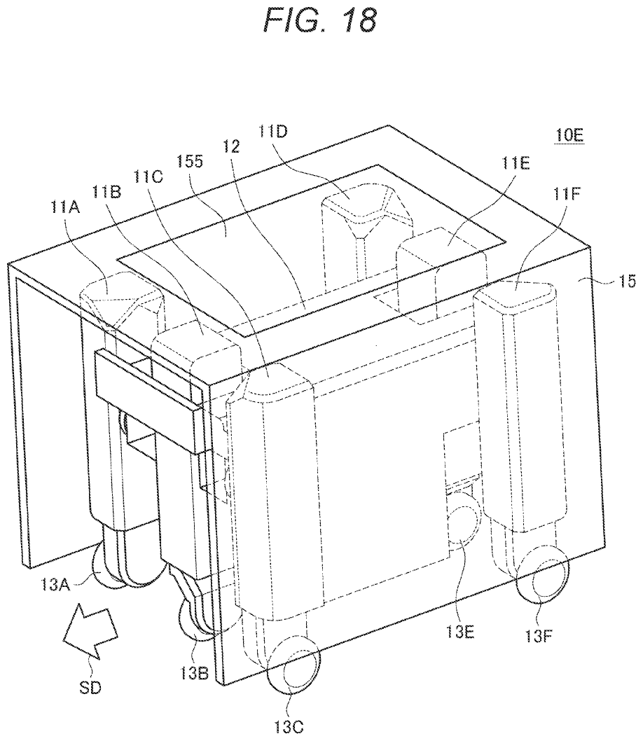

FIG. 18 is a perspective view illustrating an appearance of a mobile object 10E according to a fifth modification. As illustrated in FIG. 18, the mobile object 10E is provided with an openable lid 155 on the upper surface of the exterior portion 15. The lid 155 is opened upward to form an opening in the exterior portion 15. This facilitates access to the main body portion 12, which improves the mobile object 10E in maintainability. In addition, in a case where the exterior portion 15 is externally provided with a device, the lid 155 provided on the upper surface of the exterior portion 15 can facilitate wiring between the device externally provided to the exterior portion 15 and the main body portion 12.

### Sixth Modification

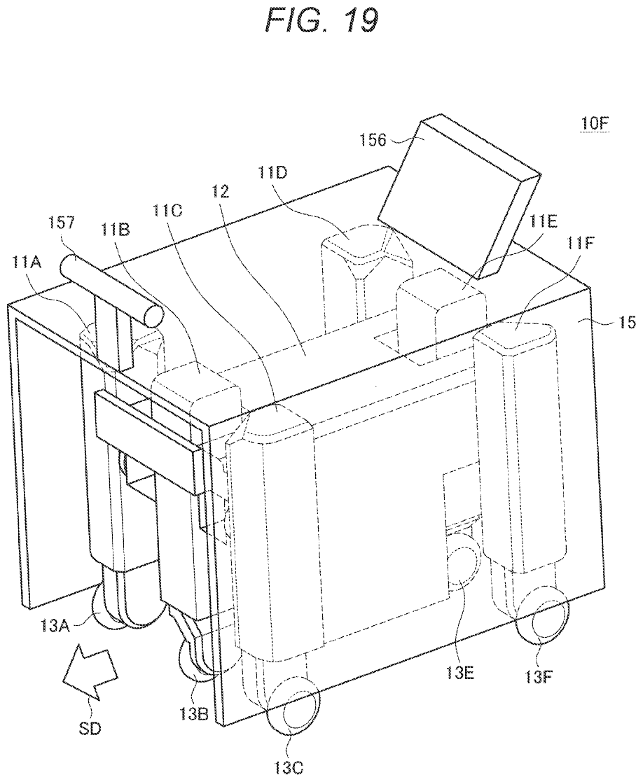

FIG. 19 is a perspective view illustrating an appearance of a mobile object 10F according to a sixth modification. As illustrated in FIG. 19, the mobile object 10F is provided with a handle 157 and a backrest 156 on the upper surface of the exterior portion 15. With this configuration, the traveling direction of the mobile object 10F is controlled via operation of the handle 157 by a user riding on the upper surface of the exterior portion 15. Since the legs 11 are covered by the exterior portion 15, the user can ride the mobile object 10F by straddling on the exterior portion 15. Therefore, the mobile object 10F can allow the user to ride and move to the destination more safely.

### 3. Specific Example

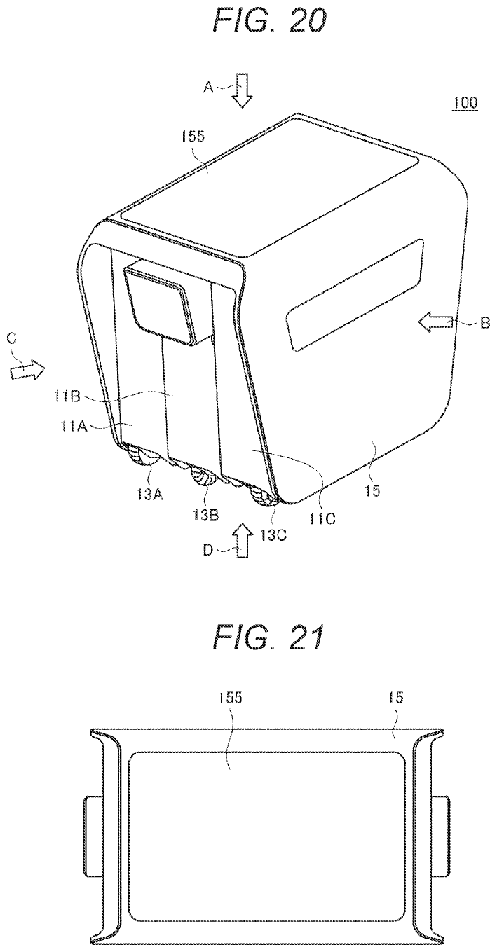

Furthermore, a specific example of the mobile object 10 according to the present embodiment will be described with reference to FIGS. 20 to 36.

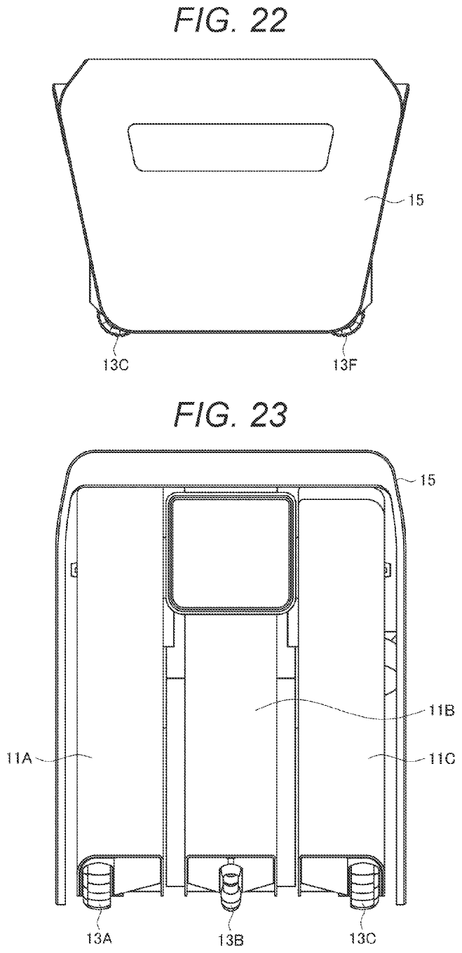

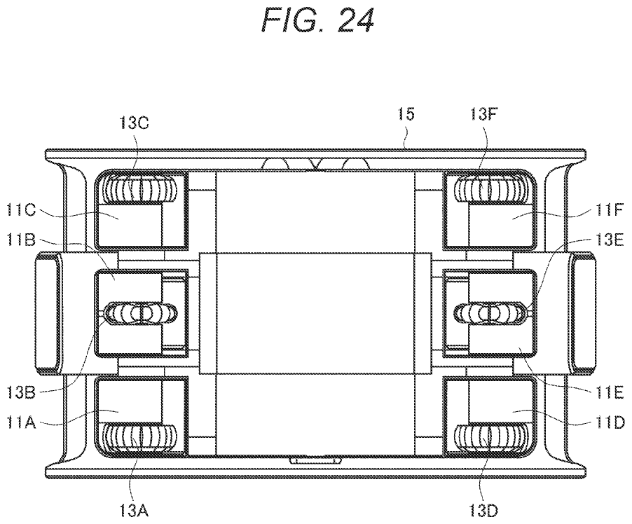

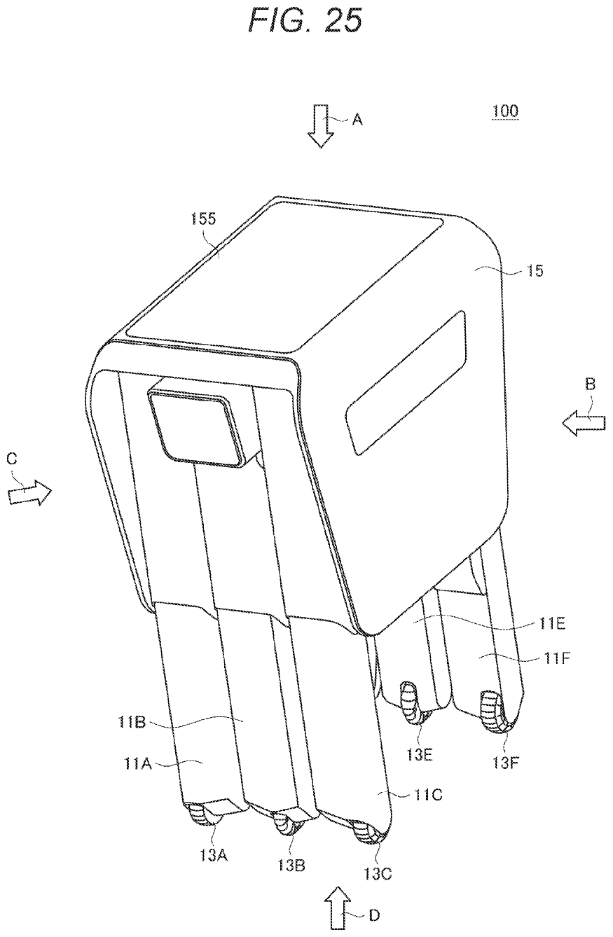

FIG. 20 is a perspective view illustrating an appearance of a mobile object 100 according to a specific example. FIG. 21 is a top view of the mobile object 100 illustrated in FIG. 20 in direction A. FIG. 22 is a side view of the mobile object 100 illustrated in FIG. 20 in direction B. FIG. 23 is a front view of the mobile object 100 illustrated in FIG. 20 in direction C. FIG. 24 is a bottom view of the mobile object 100 illustrated in FIG. 20 in direction D. FIGS. 20 to 24 illustrate a state in which the mobile object 100 has each leg 11 contracted.

As illustrated in FIGS. 20 to 24, the mobile object 100 includes six legs 11A, 11B, 11C, 11D, 11E, and 11F in which wheels 13A, 13B, 13C, 13D, 13E, and 13F are provided on the distal end side. An exterior portion 15 is provided on both side surfaces in the pitch axis direction and an upper surface of the mobile object 100. In addition, an openable lid 155 is provided on an upper surface of the exterior portion 15. The mobile object 100 can travel on the wheels by, for example, driving the wheels 13 in the state illustrated in FIGS. 20 to 24.

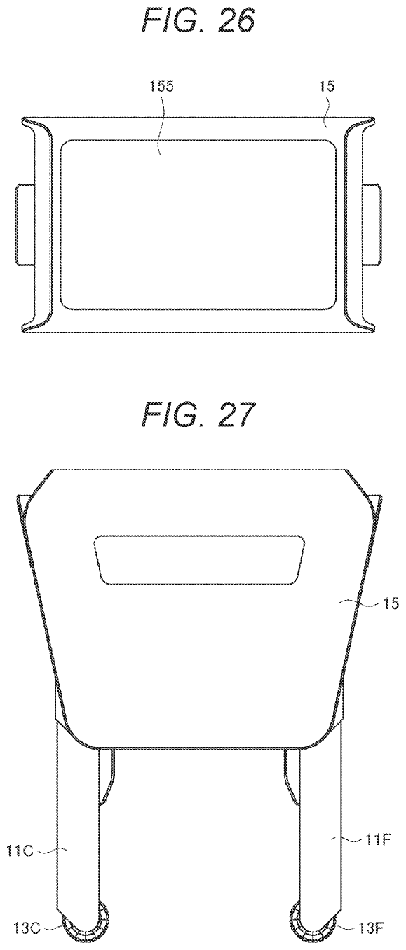

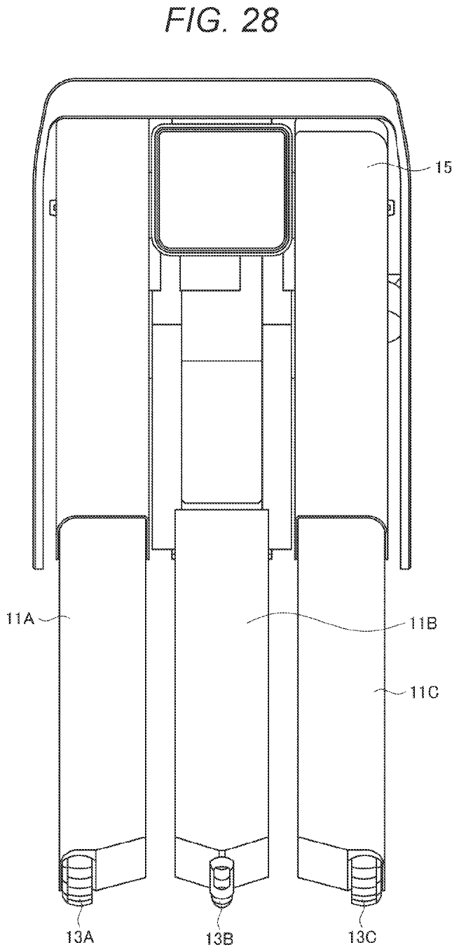

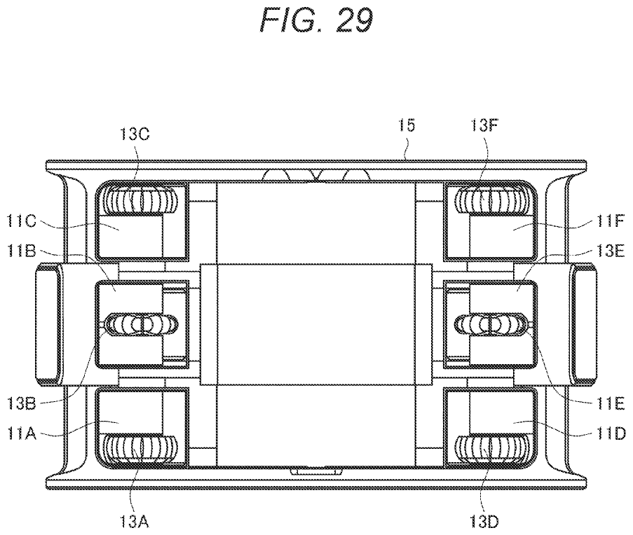

FIG. 25 is a perspective view illustrating an appearance of the mobile object 100 in a state where each leg 11 is extended. FIG. 26 is a top view of the mobile object 100 illustrated in FIG. 25 in direction A. FIG. 27 is a side view of the mobile object 100 illustrated in FIG. 25 in direction B. FIG. 28 is a front view of the mobile object 100 illustrated in FIG. 25 in direction C. FIG. 29 is a bottom view of the mobile object 100 illustrated in FIG. 25 in direction D.

As illustrated in FIGS. 25 to 29, the mobile object 100 can extend each of the six legs 11A, 11B, 11C, 11D, 11E, and 11F. For example, the mobile object 100 can walk on the legs by rotating and extending and contracting each of the legs 11 from the state illustrated in FIGS. 25 to 29.

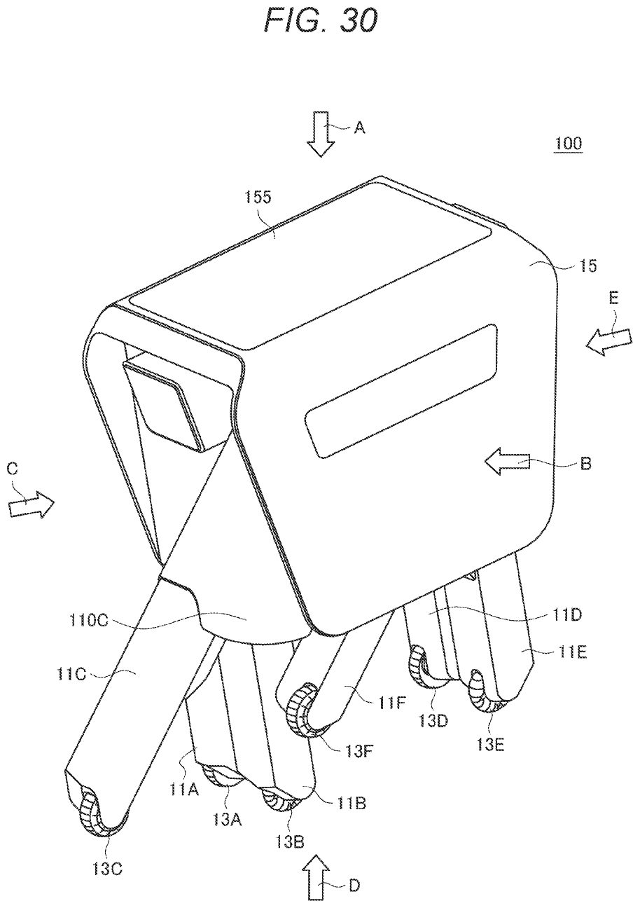

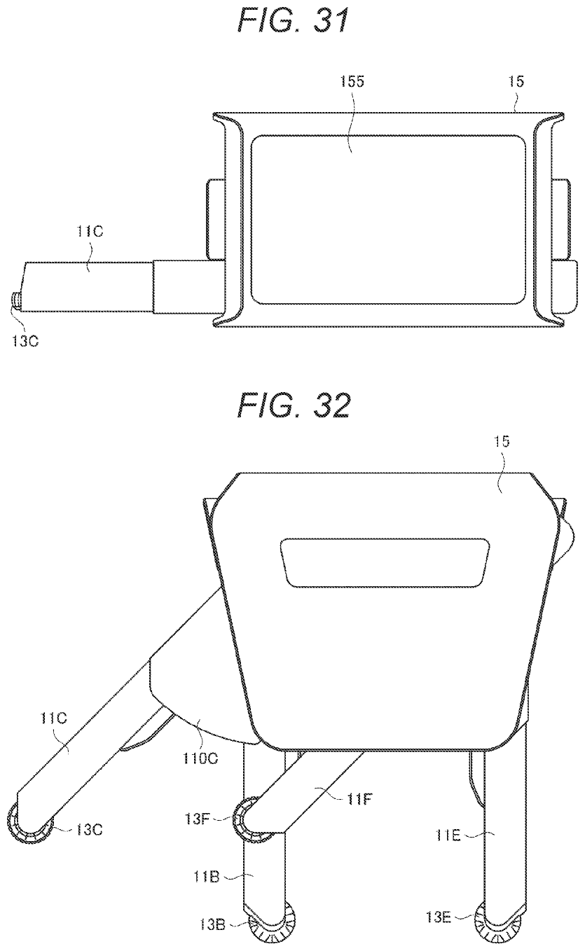

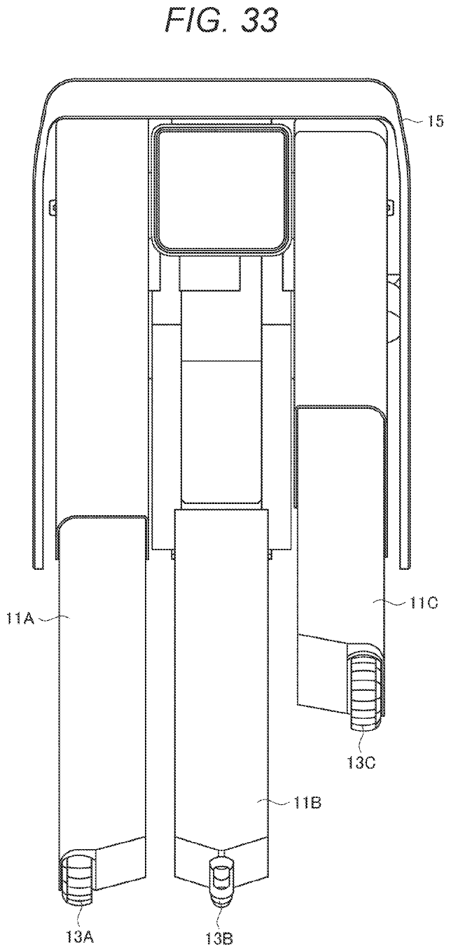

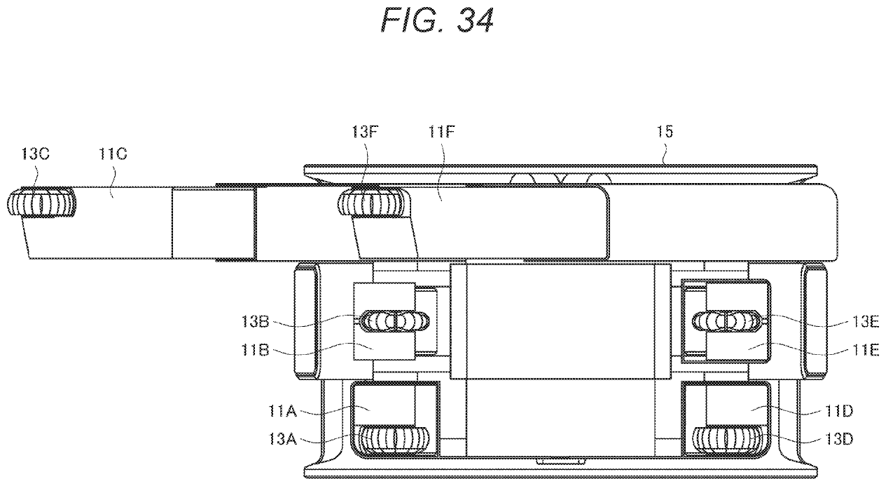

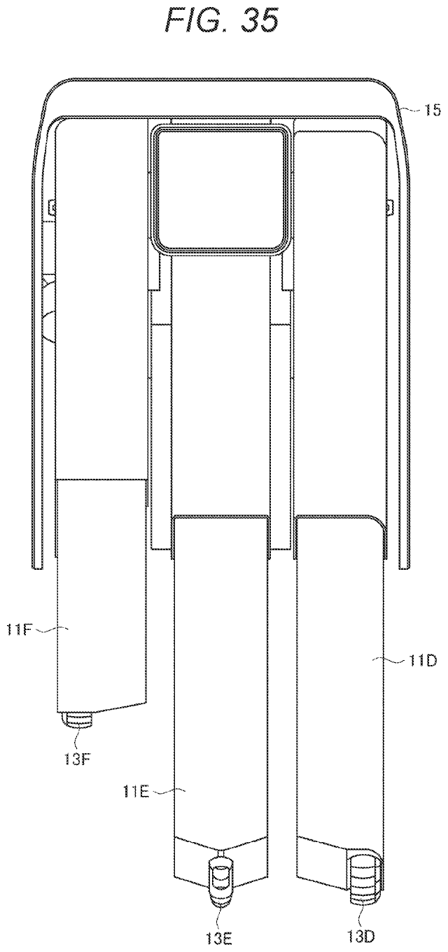

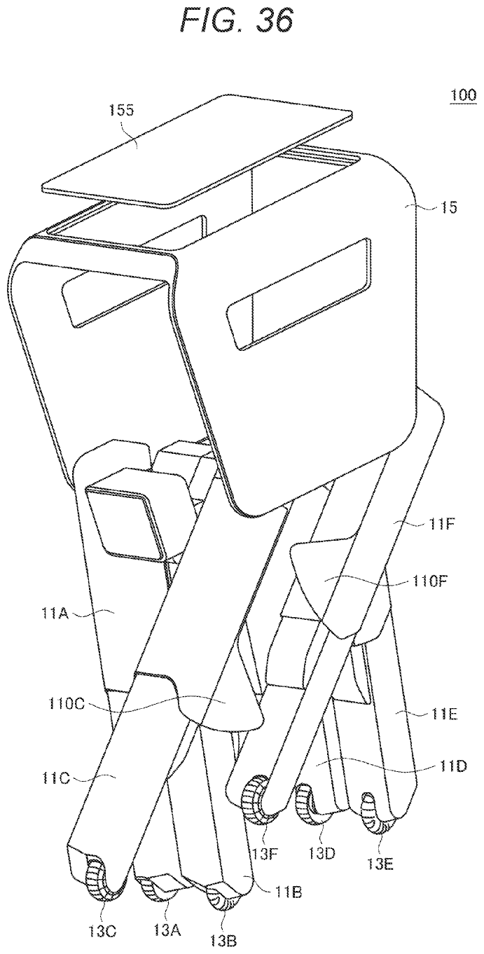

FIG. 30 is a perspective view illustrating an appearance of the mobile object 100 in a state where the legs 11C and 11F are swung out in the traveling direction. FIG. 31 is a top view of the mobile object 100 illustrated in FIG. 30 in direction A. FIG. 32 is a side view of the mobile object 100 illustrated in FIG. 30 in direction B. FIG. 33 is a front view of the mobile object 100 illustrated in FIG. 30 in direction C. FIG. 34 is a bottom view of the mobile object 100 illustrated in FIG. 30 in direction D. FIG. 35 is a back view of the mobile object 100 illustrated in FIG. 30 in direction E. FIG. 36 is a perspective view of the mobile object 100 illustrated in FIG. 30 in which the exterior portion 15 is exploded.

As illustrated in FIGS. 30 to 35, the leg 11C swung out in the traveling direction is provided with a projecting portion 110C that covers the leg 11C and expands opposite to the traveling direction. Since the gap between the leg 11C swung out and the exterior portion 15 is covered by the projecting portion 110C, the mobile object 100 can prevent an outside object from being caught between the leg 11C and the exterior portion 15. With this configuration, the mobile object 100 can be improved in safety during walking on the legs.

In addition, the exterior portion 15 is provided on both side surfaces in the pitch axis direction and the upper surface of the mobile object 100 so as to cover the mobile object 100, as illustrated in FIG. 36. In addition, an openable lid 155 is provided on an upper surface of the exterior portion 15.

The preferred embodiment of the present disclosure has been described above in detail with reference to the accompanying drawings, but the technical scope of the present disclosure is not limited to such examples. It is obvious that those with ordinary skill in the technical field of the present disclosure can conceive various changes or modifications within the scope of the technical idea recited in the claims, and it is naturally understood that these changes or modifications also fall within the technical scope of the present disclosure.

In addition, the effects described in the present specification are merely exemplary or illustrative, and not restrictive. That is, the technology according to the present disclosure may exert other effects apparent to those skilled in the art from the description of the present specification, in addition to or instead of the effects described above.

Note that the following configurations also fall within the technical scope of the present disclosure.

(1)

A mobile object including:
a main body portion;
a plurality of legs connected to the main body portion via joints rotatable about an axis extending in a first direction that is parallel to a traveling surface; and an exterior portion that covers both sides in the first direction of the main body portion and an upper side of the main body portion opposite to a side near the traveling surface to enclose the main body portion and the plurality of legs.
   (2)

The mobile object according to (1) described above, in which the exterior portion has a shape in which both sides in a second direction orthogonal to the first direction in a plane parallel to the traveling surface are opened.

(3)

The mobile object according to (2) described above, in which the exterior portion is connected to an upper surface of the main body portion at a plurality of connecting regions separated from each other in the first direction and at a plurality of connecting regions separated from each other in the second direction.

(4)

The mobile object according to (3) described above, in which the exterior portion is connected to both side surfaces in the first direction of the main body portion at respective connecting regions provided at a central portion in the second direction.

(5)

The mobile object according to (4) described above, in which the main body portion has a shape in which the central portion in the second direction protrudes to each of both sides in the first direction.

(6)

The mobile object according to any one of (3) to (5) described above, in which at least two or more connecting portions are provided at each of the connecting regions.

(7)

The mobile object according to any one of (2) to (6) described above, in which a rib portion is provided on an upper portion of the opening in the second direction of the exterior portion to partially shield the opening.

(8)

The mobile object according to any one of (2) to (7) described above, in which the plurality of legs includes a plurality of links that is linearly movable or rotatable with respect to each other.

(9)

The mobile object according to (8) described above, in which each of the plurality of legs has a distal end provided with a wheel that grounds on the traveling surface, the distal end being opposite to a rear end at which the leg is connected to the main body portion.

(10)

The mobile object according to either (8) or (9) described above, in which each of the plurality of legs is provided with a projecting portion projecting toward a central portion in the second direction of the main body portion.

(11)

The mobile object according to (10) described above, in which the projecting portion has a shape that reversely tapers toward a distal end opposite to a rear end at which the leg is connected to the main body portion.

(12)

The mobile object according to (11) described above, in which
the projecting portion includes a plurality of fan-shaped members having a connection point as a vertex provided on the leg, and the plurality of fan-shaped members is provided so as to be rotatable relative to each other about the connection point.
   (13)

The mobile object according to (11) described above, in which
the plurality of legs is provided to be separated from each other in the second direction, and the projecting portions each provided on a corresponding one of the plurality of legs are provided so as to be displaced from each other in the first direction so as to be capable of passing next to each other.
   (14)

The mobile object according to any one of (2) to (13) described above, in which
the plurality of legs includes six legs, and
the plurality of legs includes three front legs provided on one surface side in the second direction of the main body portion and three rear legs provided on another surface side opposite to the one surface side of the main body portion.
   (15)

The mobile object according to any one of (1) to (14) described above, in which a display unit is provided on an outer side of a side surface in the first direction of the exterior portion.

(16)

The mobile object according to any one of (1) to (15) described above, in which a detection unit that detects approach of or contact with an object is provided on an outer side of a side surface in the first direction of the exterior portion.

(17)

The mobile object according to any one of (1) to (16) described above, in which an openable lid is provided on an upper surface of the exterior portion.

(18)

A robot apparatus including:
a main body portion;
a plurality of legs connected to the main body portion via joints rotatable about an axis extending in a first direction that is parallel to a traveling surface; and
an exterior portion that covers both sides in the first direction of the main body portion and an upper side of the main body portion opposite to a side near the traveling surface to enclose the main body portion and the plurality of legs.

### REFERENCE SIGNS LIST

1, 10, 10A, 10B, 10C, 10D, 10E, 10F, 100 Mobile object
3 Mobile object main body
11, 11A, 11B, 11C, 11D, 11E, 11F Leg
12 Main body portion
13, 13A, 13B, 13C, 13D, 13E, 13F Wheel
15 Exterior portion
16, 16A, 16B, 16C, 16D, 16E, 16F Connecting portion
110 Projecting portion
111 Fan-shaped member
112 Connection point
113 Elastic member
151 Rib portion
152 Output unit
153 Detection unit
155 Lid
156 Backrest
157 Handle
171 Display unit
172 Wiring group
173 Control device
SD Traveling direction

1. A mobile object comprising:
a main body portion;
a plurality of legs connected to the main body portion via joints rotatable about an axis extending in a first direction that is parallel to a traveling surface; and
an exterior portion that covers both sides in the first direction of the main body portion and an upper side of the main body portion opposite to a side near the traveling surface to enclose the main body portion and the plurality of legs.

2. The mobile object according to claim 1, wherein the exterior portion has a shape in which both sides in a second direction orthogonal to the first direction in a plane parallel to the traveling surface are opened.

3. The mobile object according to claim 2, wherein the exterior portion is connected to an upper surface of the main body portion at a plurality of connecting regions separated from each other in the first direction and at a plurality of connecting regions separated from each other in the second direction.

4. The mobile object according to claim 3, wherein the exterior portion is connected to both side surfaces in the first direction of the main body portion at respective connecting regions provided at a central portion in the second direction.

5. The mobile object according to claim 4, wherein the main body portion has a shape in which the central portion in the second direction protrudes to each of both sides in the first direction.

6. The mobile object according to claim 3, wherein at least two or more connecting portions are provided at each of the connecting regions.

7. The mobile object according to claim 2, wherein a rib portion is provided on an upper portion of the opening in the second direction of the exterior portion to partially shield the opening.

8. The mobile object according to claim 2, wherein the plurality of legs includes a plurality of links that is linearly movable or rotatable with respect to each other.

9. The mobile object according to claim 8, wherein each of the plurality of legs has a distal end provided with a wheel that grounds on the traveling surface, the distal end being opposite to a rear end at which the leg is connected to the main body portion.

10. The mobile object according to claim 8, wherein each of the plurality of legs is provided with a projecting portion projecting toward a central portion in the second direction of the main body portion.

11. The mobile object according to claim 10, wherein the projecting portion has a shape that reversely tapers toward a distal end opposite to a rear end at which the leg is connected to the main body portion.

12. The mobile object according to claim 11, wherein
the projecting portion includes a plurality of fan-shaped members having a connection point as a vertex provided on the leg, and
the plurality of fan-shaped members is provided so as to be rotatable relative to each other about the connection point.

13. The mobile object according to claim 11, wherein
the plurality of legs is provided to be separated from each other in the second direction, and
the projecting portions each provided on a corresponding one of the plurality of legs are provided so as to be displaced from each other in the first direction so as to be capable of passing next to each other.

14. The mobile object according to claim 2, wherein
the plurality of legs comprises six legs, and
the plurality of legs includes three front legs provided on one surface side in the second direction of the main body portion and three rear legs provided on another surface side opposite to the one surface side of the main body portion.

15. The mobile object according to claim 1, wherein a display unit is provided on an outer side of a side surface in the first direction of the exterior portion.

16. The mobile object according to claim 1, wherein a detection unit that detects approach of or contact with an object is provided on an outer side of a side surface in the first direction of the exterior portion.

17. The mobile object according to claim 1, wherein an openable lid is provided on an upper surface of the exterior portion.

18. A robot apparatus comprising:
a main body portion;
a plurality of legs connected to the main body portion via joints rotatable about an axis extending in a first direction that is parallel to a traveling surface; and
an exterior portion that covers both sides in the first direction of the main body portion and an upper side of the main body portion opposite to a side near the traveling surface to enclose the main body portion and the plurality of legs.
